(19) United States
(12) Patent Application Publication
(10) Pub. No.: US 2014/0113576 A1
(43) Pub. Date: Apr. 24, 2014

(54) Method and Apparatus for Signal Reception

(71) Applicant: Renesas Mobile Corporation, Tokyo (JP)

(72) Inventors: Markus NENTWIG, Helsinki (FI); Liangge XU, Espoo (FI)

(73) Assignee: Renesas Mobile Corporation, Tokyo (JP)

(21) Appl. No.: 14/055,023

(22) Filed: Oct. 16, 2013

(30) Foreign Application Priority Data
Oct. 18, 2012 (GB) 1218745.6

(51) Int. Cl. H04B 1/10

(52) U.S. Cl. CPC H04B 1/1027
USPC 455/84

(57) ABSTRACT

A preferred embodiment of the present invention relates generally to enhancing quality of a received signal in a receiver. The received signal can be enhanced by reducing phase noise. A described method starts with determining input information, wherein the input information comprises at least one of the following pieces of information: a modulation-and-coding scheme of the received signal, a multiple-antenna configuration (MIMO configuration), a signal quality estimate of the received signal, or a frequency separation between the received signal and a transmitted signal. The method continues with selecting a bandwidth value on the basis of the input information. The selecting should result in such a bandwidth value which has an advantageous effect to the quality of the received signal. This advantageous effect is achieved by performing the following: using the bandwidth value for generating a local oscillator signal, and shaping the received signal with the local oscillator signal.

### CROSS REFERENCE TO A RELATED APPLICATION

This application claims the benefit under 35 U.S.C. §119(a) and 37 CFR §1.55 to UK patent application no. GB1218745.6, filed on 18 Oct. 2012, the entire content of which is incorporated herein by reference.

### BACKGROUND OF THE INVENTION

1. Field of the Invention

Examples described in the present application relate generally to radio receivers and down-converting a received signal in a radio receiver. Examples described in the present application also relate to radio access networks, such as Universal Mobile Telecommunication System (UMTS), Universal Terrestrial Radio Access Network (UTRAN), a Long Term Evolution (LTE) network called Evolved UTRAN (E-UTRAN), LTE advanced, a Wideband Code Division Multiple Access (WCDMA), and a High Speed Packet Access (HSPA) network.

2. Description of the Related Technology

In a radio access network (RAN) a base station, or an evolved Node B (eNB) in LTE, assigns radio resources to a user equipment (UE). In time division systems the radio resources are short time periods, such as 1 ms. These periods are termed time slots, frames, or subframes depending on the RAN in which they are used. Alternatively, the radio resources may be radio frequencies. Thus, the base station assigns a certain time slot or a certain radio frequency to the UE to be used in a downlink transmission or in an uplink transmission. It is also possible to define the radio resources in regard to time and frequency. A duplex communication system is a point-to-point system composed of two devices, such as two radio sets, which are able to communicate in both directions simultaneously. The duplex communication system provides a two-way communication channel between the devices. A term multiplexing refers to mediating pair wise communication between more than one pair of devices. The multiplexing enables a number of devices to use the same communication channel in the same time. Time division duplex (TDD) and frequency division duplex (FDD) are known techniques for sharing the communication channel. A half-duplex system allows communication in both directions, but only one direction at a time. Conversely, a full-duplex system allows the communication simultaneously in the both directions.

FIG. 1 shows a transceiver 101 that can be used, for example, in base stations or UEs. Transceiver 101 comprises a receiver 102, a transmitter subsystem 103, a duplex filter 104, a low-noise amplifier 105, an antenna 106, and a modem 107. Modem 107 generates a baseband data stream which is an input for transmitter subsystem 103 comprising a digital-to-analog converter (DAC) 108, a mixer 109, a synthesizer 110, and a power amplifier 111. Digital-to-analog converter 108 converts the baseband data stream to an analog signal. Mixer 109 upconverts the analog signal with an oscillator signal obtained from synthesizer 110, and results in a radio frequency signal. Then the radio frequency signal is amplified by power amplifier 111 and transmitted through duplex filter 104 and antenna 106. The signal emitted from antenna 106 is termed a transmitted signal 112. Transceiver 101 runs simultaneously a process of signal transmission and a process of signal reception, thus its operation mode is full-duplex (a processor and a memory are omitted from the figure). A signal received through antenna 106 is termed a received signal 114. The terms “received signal” and “transmitted signal” relate to various kinds of communication systems, not only to the full-duplex system of FIG. 1.

A signal can be generally characterized in terms of bandwidth and signal-to-noise ratio (SNR). A “wanted” signal is a signal which is similar to an original signal and this original signal is, for example, transmitted signal 112 sent from transmitter subsystem 103. A received signal is a mixture of the wanted signal and unwanted signals, such as leakage signals and blocker signals. Especially full-duplex systems suffer from leakage signals. For example, transmitted signal 112 may include frequencies which at least partly overlap the frequency band of received signal 114. In other words, transmitted signal 112 “leaks” on the frequency band of the received signal 114.

Down-conversion of the received signal is performed using a local oscillator (LO) signal at a carrier frequency generated by a synthesizer (Sx). The synthesizer comprises a phase locked loop with a configurable loop filter. The synthesizer generates phase noise as a side effect. The configurable loop filter affects the spectrum of the phase noise.

The following example discloses how the quality of the LO signal can be enhanced and thus also the quality of the output signal of the receiver can be enhanced.

FIG. 2 is a block diagram of a receiver 201 which is described in detail in US2011280344. Receiver 201 comprises a low-noise amplifier (LNA) 202, a mixer 203, a low-pass filter 204, a received signal strength indicator (RSSI) 205, and a PLL 206, wherein PLL 206 is a type of fractional-N PLL. Low-noise amplifier 202 amplifies the received signal obtained from an antenna 207 and supplies the amplified received signal to mixer 203. Low-pass filter 204 is adapted to filter out at least a portion of the unwanted signals that may be present in the amplified received signal. RSSI 205 is adapted to detect blocker signals that may be present in an output signal of low-pass filter 204 and supply a feedback signal 208 to PLL 206. In response to feedback signal 208, PLL 206 emits a LO signal to mixer 203 and mixer 203 uses the LO signal to convert the frequency of the signal which it receives from LNA 202. The bandwidth of PLL 206 is dynamically controlled in response to the output signal 209 of receiver 201. In more detail, the bandwidth of PLL 206 is controlled in response to presence or absence of a blocker signal. During its operation, RSSI 205 monitors the strengths of the blocker signal. If the blocker signal detected by RSSI has strength greater than a predefined threshold value, the feedback signal 208 of RSSI is set to a first logic level. Correspondingly, if the blocker signal has strength smaller than or equal to the predefined threshold value, feedback signal 208 of RSSI 205 is set to a second logic level. The feedback signal effects to the bandwidth of PLL 206 in the following way. In response to the first logic level of feedback signal 208, the bandwidth of PLL 206 is decreased to reduce an out-of-band noise of the LO signal supplied by PLL 206 to mixer 203. Correspondingly, in response to the second logic level of feedback signal 208, the bandwidth of PLL 206 is increased to reduce an in-band noise of the LO signal. The reducing of the out-of-band noise and the in-band noise enhances the quality of the converted signal generated by mixer 203 from received signal and LO signal.

A LO signal contains unwanted phase noise components that can be classified as “near” and “far” phase noise components. “Near” phase noise components are located at frequencies close to the wanted signal, and they cause reciprocal mixing products with the wanted signal that fall into the bandwidth of the wanted signal and thus deteriorate the quality of a received signal. Conversely, “far” phase noise components are located at frequencies sufficiently remote from the wanted signal, and their reciprocal mixing products with the wanted signal fall outside the wanted signal bandwidth where they do not deteriorate the signal reception. A far phase noise component, however, may interact with other unwanted signals in the same frequency range, such as blockers or transmit leakage signals, and cause reciprocal mixing products that overlap the bandwidth of the wanted signal and thus degrade the quality of the received signal.

Radio transmissions with multiple transmit and receive antennas are referred to as “MIMO” (multiple input multiple output). Multiple antennas can be utilized in various manners. In a first MIMO technique multiple transmit antennas are used to send the same data on the same frequency. In a second MIMO technique multiple receive antennas are used to receive the same data on the same frequency. The above-mentioned first and second technique can be utilized separately or together, i.e. the techniques can also be used simultaneously. Given a sufficiently rich fading channel, MIMO may establish an independent MIMO stream between each transmit- and receive antenna and thus considerably improve the throughput over a radio channel. However, MIMO may be sensitive to reciprocal mixing product appearing in multiple MIMO streams that are correlated. Correlated reciprocal mixing products may result both from utilizing the same LO signal in multiple receivers to process received signals from multiple receive antennas, and from a single receiver down converting the sum of transmit signals from multiple transmit antennas in parallel. The error caused by correlated reciprocal mixing products can severely impair the reception of the MIMO signal.

A modulation-and-coding scheme (MCS) is a scheme for transmitting a signal. A modulation-and-coding scheme may be selected in link adaption, where a transmitter attempts to maximize a throughput to a receiver by selecting the highest-order modulation format and coding scheme that meets a required measure of quality, such as a bit error rate, for a given radio link. The radio link may be characterized by a pathloss of the received signal, interference by signals coming from transmitters, the sensitivity of the receiver, etc. Examples for modulation schemes are QPSK (quadrature phase shift keying), providing a low spectral efficiency but low demands on signal quality, and 64 QAM (quadrature amplitude modulation), resulting in a better spectral efficiency but requiring a better signal quality. Examples for coding are convolutional codes or Turbo codes with code rates. For example, a low code rate of ⅓ may carry only one bit of information in three transmitted bits, and a high code rate of 9/10 may carry nine bits of information in ten transmitted bits. In general, a higher code rate results in a higher data throughput but requires a better signal quality than a lower code rate. A modulation-and-coding scheme that employs QPSK or 64 QAM in combination with a predetermined coding rate may be referred to as “QPSK-based” or “64 QAM-based”.

Designing a synthesizer with good phase noise performance at both near and far frequency offsets is inefficient, as it increases the power consumption, which is especially problematic in a battery-powered UE such as a cell phone. There is need for a more efficient solution to prevent degradation of a received signal in a receiver of the UE, wherein the degradation is caused by phase noise.

### SUMMARY

A preferred embodiment of the invention aims to prevent or mitigate degradation of a received signal with low power consumption.

In a first exemplary embodiment there is a method of enhancing quality of a received signal in a receiver, the method comprising: determining input information that comprises at least one of the following pieces of information: a modulation-and-coding scheme of the received signal; a multiple-antenna configuration; a signal quality estimate of the received signal; a frequency separation between the received signal and a transmitted signal; and selecting a bandwidth value on the basis of the input information; using the bandwidth value for generating a local oscillator signal; and shaping the received signal with the local oscillator signal.

In one embodiment of the method, the bandwidth value controls a bandwidth of a phase noise component in the local oscillator signal.

In one embodiment of the method, the using of the bandwidth value comprises a selection of an oscillator core.

In one embodiment of the method, the generating of the local oscillator signal comprises a frequency division operation.

In one embodiment of the method, the generating of the local oscillator signal comprises use of a feedback loop.

In one embodiment of the method, the input information comprises at least two of the following pieces of information:

the modulation-and-coding scheme of the received signal

the multiple-antenna configuration

the signal quality estimate of the received signal

the frequency separation between the received signal and a transmitted signal.

In one embodiment of the method, the selecting is performed taking into account the at least two pieces of information.

In one embodiment of the method, the signal quality estimate is a channel quality indicator.

In one embodiment of the method, the frequency separation is determined on the basis of a threshold value.

In one embodiment of the method, the frequency separation is determined on the basis of on a band used by the receiver, the band comprising an uplink frequency band and a downlink frequency band.

In one embodiment of the method, the selecting comprises use of a conditional clause.

In one embodiment of the method, the conditional clause comprises at least one predefined threshold values.

In a second exemplary embodiment of the invention there is an apparatus, comprising at least one processor and at least one memory including computer program code, the at least one processor and the computer program code configured to, with the at least one processor, cause the apparatus to perform, at a user equipment, at least the following: determining input information that comprises at least one of the following pieces of information: a modulation-and-coding scheme of the received signal; a multiple-antenna configuration; a signal quality estimate of the received signal; a frequency separation between the received signal and a transmitted signal; and selecting a bandwidth value on the basis of the input information; using the bandwidth value for generating a local oscillator signal; shaping a received signal with the local oscillator signal to enhance quality of the received signal in a receiver.

In one embodiment of the apparatus, the bandwidth value controls a bandwidth of a phase noise component in the local oscillator signal.

In one embodiment of the apparatus, the using of the bandwidth value comprises a selection of an oscillator core.

In one embodiment of the apparatus, the generating of the local oscillator signal comprises a frequency division operation.

In one embodiment of the apparatus, the generating of the local oscillator signal comprises use of a feedback loop.

In one embodiment of the apparatus, the input information comprises at least two of the following pieces of information:

the modulation-and-coding scheme of the received signal

the multiple-antenna configuration

the signal quality estimate of the received signal

the frequency separation between the received signal and a transmitted signal.

In one embodiment of the apparatus, the selecting is performed taking into account the at least two pieces of information.

In one embodiment of the apparatus, the signal quality estimate is a channel quality indicator.

In one embodiment of the apparatus, the frequency separation is determined on the basis of a threshold value.

In one embodiment of the apparatus, the frequency separation is determined on the basis of on a band used by the receiver, the band comprising an uplink frequency band and a downlink frequency band.

In one embodiment of the apparatus, the selecting comprises use of a conditional clause.

In one embodiment of the apparatus, the conditional clause comprises at least one predefined threshold values.

In one embodiment of the apparatus, the apparatus comprises a signal shaper for shaping the received signal.

In one embodiment of the apparatus, the signal shaper comprises an oscillator and at least one the following devices: a mixer, divider, a phase detector, a loop filter, a phase locked loop.

In a third exemplary embodiment of the invention there is a non-transitory computer readable medium comprising a set of computer readable instructions stored thereon, which, when executed by a processing system, cause the processing system to carry out a method of enhancing quality of a received signal in a receiver, the method comprising: determining input information that comprises at least one of the following pieces of information:

a modulation-and-coding scheme of the received signal;

a multiple-antenna configuration;

a signal quality estimate of the received signal;

a frequency separation between the received signal and a transmitted signal; and selecting a bandwidth value on the basis of the input information; using the bandwidth value for generating a local oscillator signal; and shaping the received signal with the local oscillator signal.

### BRIEF DESCRIPTION OF THE DRAWINGS

For a more complete understanding of examples and embodiments of the present invention, reference is now made to the following description taken in connection with the accompanying drawings in which:

FIG. 1 shows an example of a transceiver;

FIG. 2 shows a block diagram of a known receiver;

FIG. 3 shows a method for reducing noise at a receiver;

FIG. 4A shows operation principles of an apparatus for reducing noise at a receiver;

FIG. 4B shows an embodiment of the apparatus for reducing noise;

FIG. 4C shows an embodiment of a signal shaper.

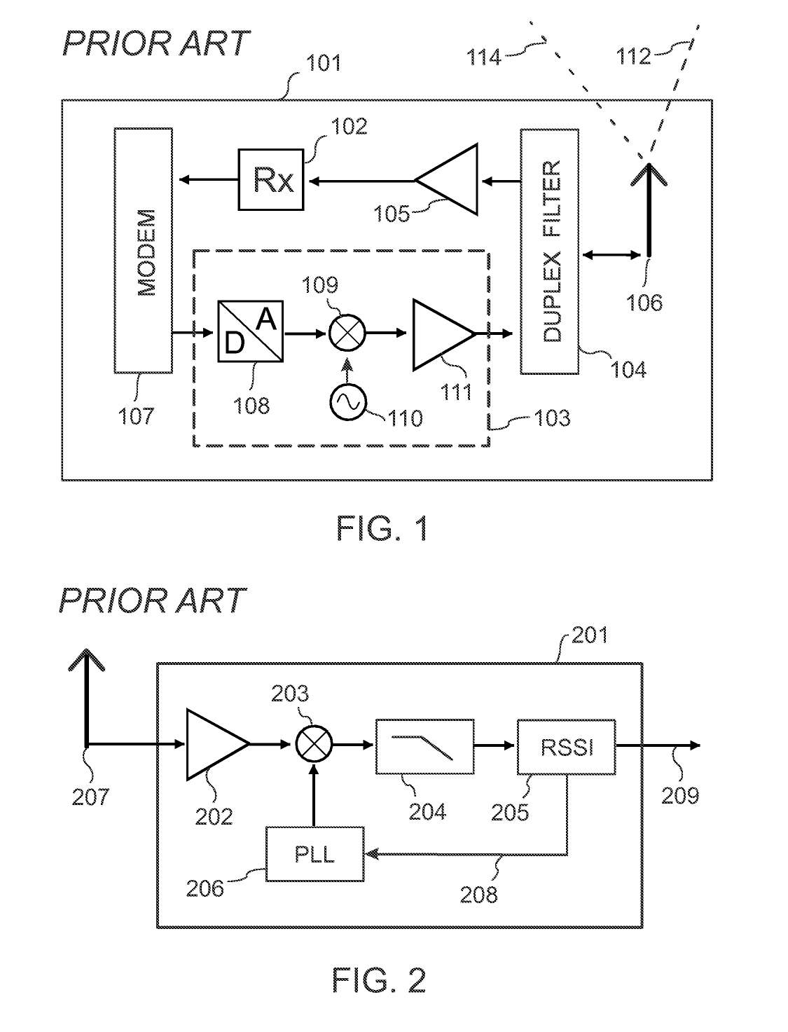

### DETAILED DESCRIPTION OF CERTAIN INVENTIVE EMBODIMENTS

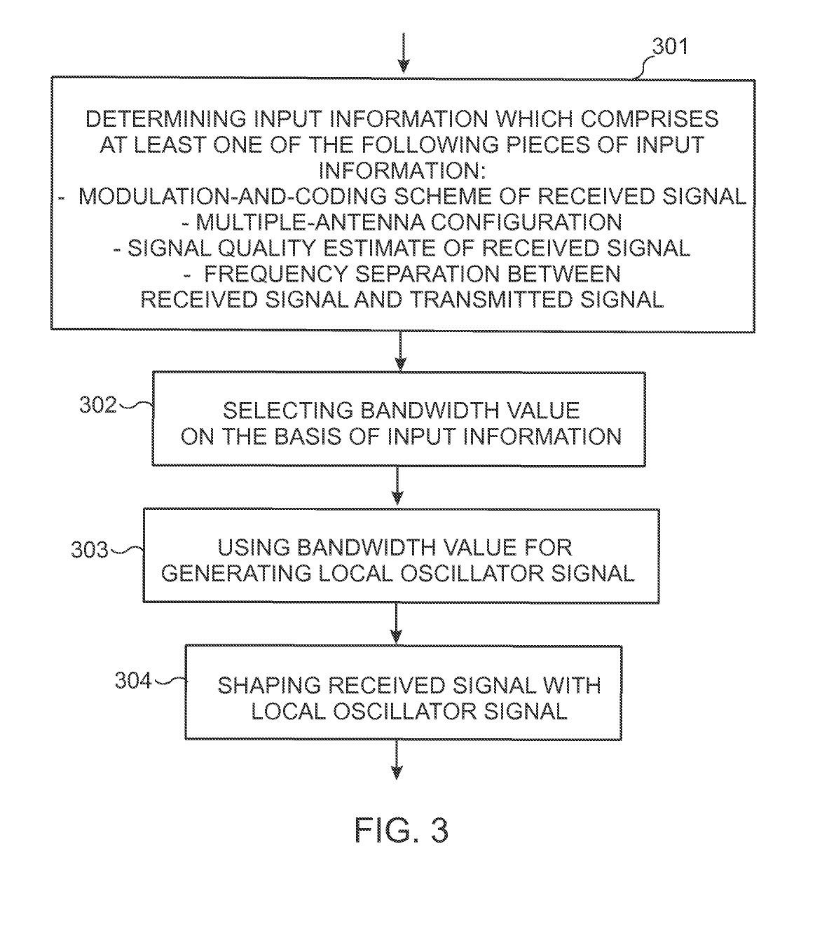

FIG. 3 shows a method of enhancing quality of a received signal in a receiver. The method starts with determining 301 input information which comprises at least one of the following pieces of information: a modulation-and-coding scheme of the received signal, a multiple-antenna configuration (MIMO configuration), a signal quality estimate of the received signal, or a frequency separation between the received signal and a transmitted signal. The method continues with selecting 302 a bandwidth value on the basis of the input information. The selecting 302 should result in such a bandwidth value which has an advantageous effect to the quality of the received signal. This advantageous effect is achieved by performing the following steps: using 303 the bandwidth value to generate a local oscillator signal and shaping 304 the received signal with the local oscillator signal. Shaping may comprise multiplying a current of the received signal with a voltage of the local oscillator signal, for example. Shaping may comprise performing a controlled change-of-sign on a current of the received signal, where the change-of-sign is controlled by a voltage of the local oscillator signal. Shaping may effect a frequency translation of the received signal with a frequency of the local oscillator signals. Methods for shaping a received signal with a local oscillator signal to effect a frequency translation are known in the art.

Generally speaking, the determining 301 results in one or more pieces of the input information and those pieces of information are used when selecting 302 the bandwidth value.

For example, the determining 301 of the input information may comprise determining a signal quality estimate of the received signal. The signal quality estimate may be, for example, a channel quality indicator or a signal-to-noise ratio. When the determining 301 results in one piece of the input information (such as the signal quality estimate of the received signal) the selecting 302 of the bandwidth value is performed on the basis of that piece of information.

The steps of determining 301 and selecting 302 are discussed in more detail in the following embodiments and examples.

In one embodiment the selecting 302 is performed taking into account the at least two pieces of the input information:

the modulation-and-coding scheme of the received signal;

the multiple-antenna configuration;

the signal quality estimate of the received signal;

the frequency separation between the received signal and a transmitted signal.

In one embodiment, the selecting 302 is performed taking into account the modulation-and-coding-scheme and the multiple-antenna configuration. In one embodiment the selecting 302 is performed taking into account the modulation-and-coding-scheme and the signal quality estimate. In one embodiment the selecting 302 is performed taking into account the multiple-antenna configuration and the signal quality estimate.

In addition to above-mentioned embodiments, there are embodiments in which the selecting 302 comprises at least three pieces of information. For example, the selecting 302 can be performed taking into account the modulation-and-coding-scheme, the multiple-antenna configuration, and the signal quality estimate.

The selecting 302 results in the bandwidth value that is used for generating the oscillator signal. In one embodiment the selecting 302 comprises selecting an alpha value. The alpha value may be the bandwidth value, but usually the alpha value is a kind of coefficient which is needed in calculation of the bandwidth value. A low alpha value may correspond to a narrow bandwidth value and a high alpha value may correspond to a high bandwidth value. An alpha value effects, in one way or other, to a bandwidth value and the bandwidth value effects to the local oscillator signal, and finally, the received signal is frequency-converted in the receiver with the local oscillator signal. Therefore, the alpha value should be selected so that it enhances the quality of the received signal.

For example, a high-order MCS requires high signal quality. In one embodiment, the selecting 302 results in a high alpha value and a high bandwidth value for the high-order MCS. In another embodiment, the high bandwidth value is selected because of MIMO. In one embodiment, a narrow bandwidth value is selected for a low-order MCS that requires only a low signal quality and is mainly used at a cell edge, where blocker signals from an adjacent cell are strong. Alternatively, the narrow bandwidth value is selected when the number of blocker signals is high.

In one embodiment, the pieces of the input information are stored in a memory and those information pieces are readable by an apparatus performing the method. The determining 301 may mean in practice, for example, that a character string “QPSK” is read from the memory and thus the modulation-and-coding scheme is determined to be QPSK-based.

In one embodiment, the determining 301 comprises determining the modulation-and-coding scheme, which is used with the received signal, and selecting 302 comprises a condition clause. This condition clause includes at least one IF-THEN clause or IF-THEN-ELSE clause. Example:

```
    Determine MCS; /* determining modulation-and-coding scheme */
    IF MCS is QPSK-based THEN
        Set alpha = 0.1; /* alpha value is 0.1, if the used MCS is QPSK-
based...*/
ELSE
        Set alpha = 0.2; /*... otherwise alpha value is 0.2 */
END IF
```

In one embodiment, the determining 301 also takes into account a signal quality estimate and selecting 302 comprises a condition clause that includes, for example, three different alpha values. In this embodiment the signal quality estimate is a channel quality indicator (CQI) and the signal quality estimate includes an estimated signal-to-noise ratio SNR intended for channel quality reporting. A user equipment reports the CQI to a base station, i.e. the value of SNR is available in the memory of the user equipment. Example:

```
    Determine SNR; /* determining signal-to-noise ratio */
    IF SNR < 21 dB THEN
        Set alpha = 0.1;
ELSE
        Determine MCS;
        IF MCS is QPSK-based THEN
            Set alpha = 0.2;
ELSE
            Set alpha = 0.3;
    END IF
END IF
```

In one embodiment, the determining 301 starts with determining the modulation-and-coding scheme after which the determining 301 continues with determining the signal quality estimate. Example:

```
    Determine MCS;
    IF MCS is QPSK-based THEN
        Set alpha = 0.1;
ELSE
        Determine SNR;
        IF SNR < 21 dB THEN
            Set alpha = 0.2;
        ELSE
            Set alpha = 0.3;
    END IF
END IF
```

As can be seen in the above examples, a condition clause may include one or more nested IF-THEN clauses, or nested IF-THEN-ELSE clauses.

In one embodiment, determining 301 comprises determining the signal quality estimate and determining the modulation-and-coding scheme, and selecting 302 comprises a condition clause including two conditions. The first condition could be “SNR>21 dB?” and the second condition could be “MCS QPSK-based?”. In addition, alpha may have a default value. Example:

Set alpha = 0.2; /* 0.2 is the default value */
Determine MCS;
Determine SNR;
IF (SNR < 21 dB AND QPSK-based) THEN
Set alpha = 0.1;
END IF

In the above examples the conditional clauses include only one predefined threshold value (21 dB). It is, however, possible that a conditional clause includes at least two predefined values. Generally speaking, the conditional clause includes at least one variable which is compared to at least one threshold value.

In one embodiment, determining 301 comprises determining a frequency separation between the received signal and the transmitted signal, wherein the frequency separation is measured in Megahertz and stored in a “MinFS” variable. In the following example also the duplex mode is taken into account. In more detail, a “FDD-mode” variable has value TRUE only if the duplex mode is FDD. Example:

```
    Set alpha = 0.2; /* default value */
    Determine MinFS; /* frequency separation */
    IF (MinFS <= 45 MHz AND FDD-mode) THEN
        Set alpha = 0.1;
END IF
```

The frequency separation may be defined as a duplex distance between a transmit frequency and a receive frequency. When considering E-UTRA bands usable in FDD, the condition “FS<45 MHz” is true for E-UTRA bands 8, 17, and 20, and the condition is false for the E-UTRA bands 1, 4 and 10, for example. In one embodiment, determining the frequency separation comprises determining, whether a device that is designed to operate in E-UTRA bands 1, 4, 8, 10, 17 and 20, is currently operating in band 8, 17 or 20. Example of the embodiment:

```
    Set alpha = 0.2;
    Determine BAND;
    IF (BAND is one of (8, 17, 20) AND FDD-mode) THEN
        Set alpha = 0.1;
END IF
```

It should be noted that while the use of the abovementioned E-UTRA bands may imply use of FDD mode, future bands may be allocated to support both TDD and FDD simultaneously. As the two previous examples indicate, a small alpha value and correspondingly a small bandwidth value may be selected if the frequency separation between the received signal and the transmitted signal is small.

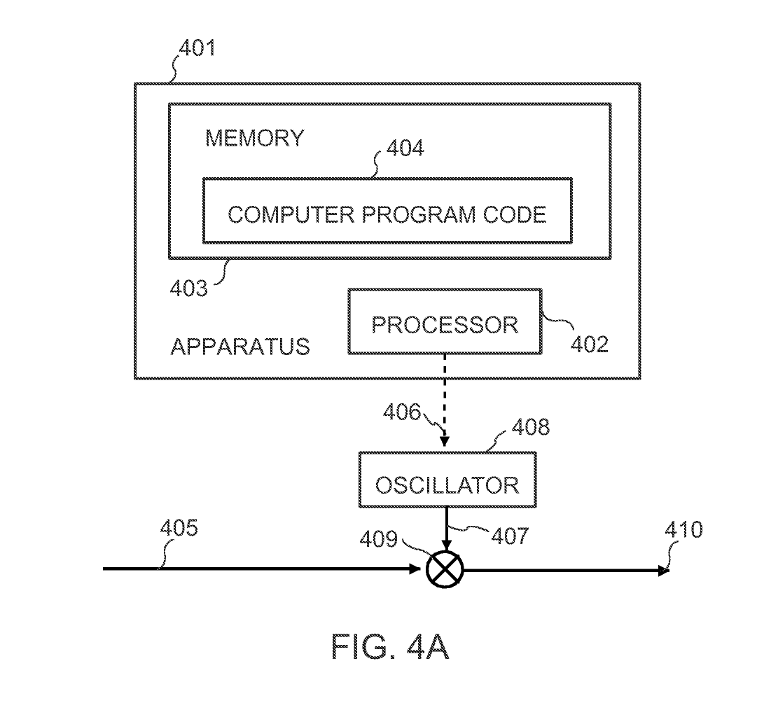

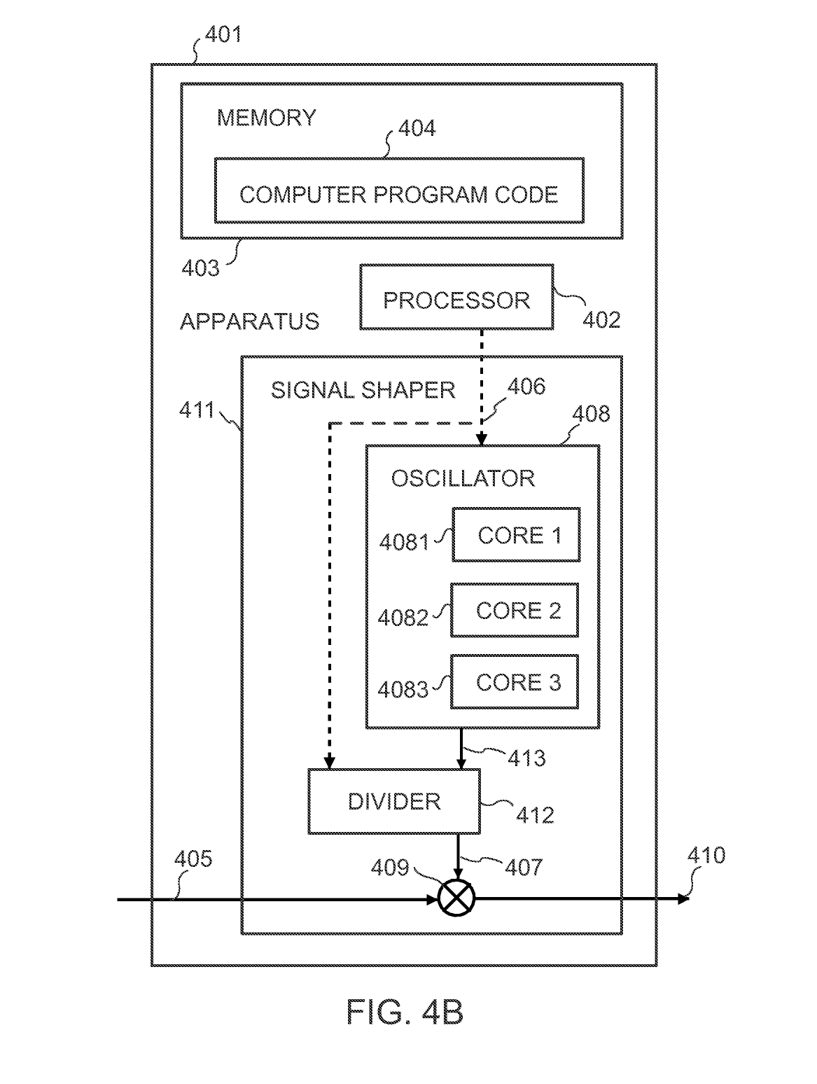

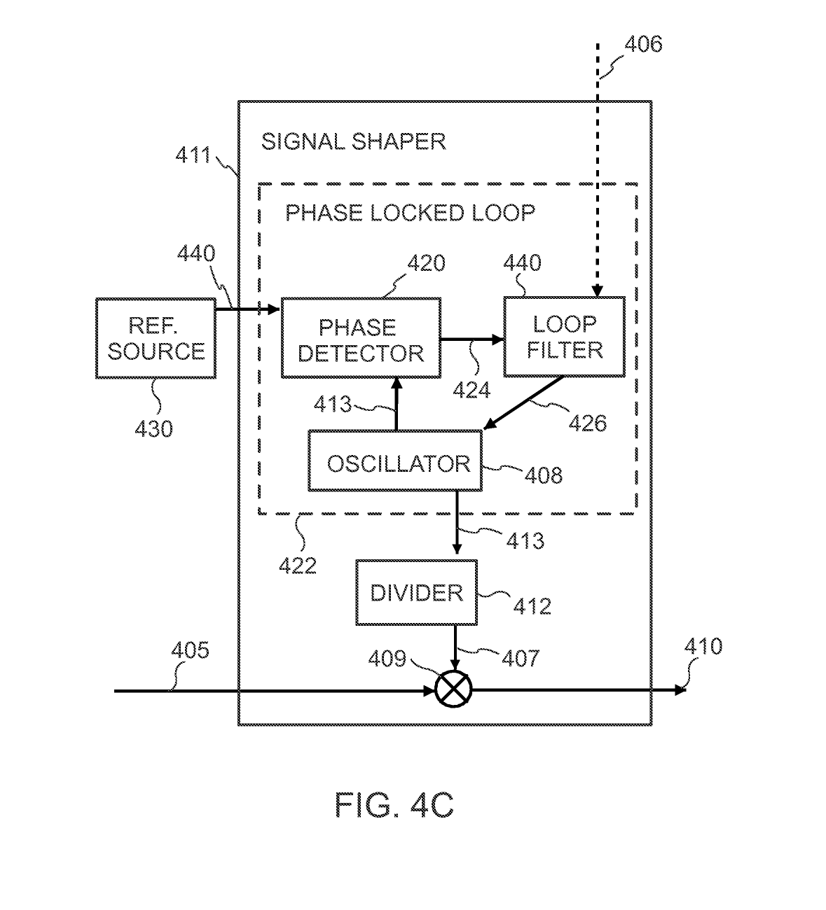

FIG. 4A shows some operation principles of an apparatus 401 for reducing noise at a receiver. Apparatus 401 comprises at least one processor 402 and at least one memory 403 including computer program code 404. Computer program code 404 is arranged to, with the at least one processor 402, cause apparatus 401 to perform the following. Apparatus 401 determines at least one the following piece of input information: a MCS scheme of a received signal 405, a MIMO configuration, a signal quality estimate of the received signal, or the frequency separation between the received signal and a transmitted signal. Apparatus 401 selects a bandwidth value 406 on the basis of the input information. As mentioned in the above, the input information is, for example, the alpha value. In one embodiment, the alpha value is (as such) the bandwidth value. In another embodiment, the alpha value effects to the bandwidth value. For example, the alpha value may be a coefficient in a formula which results in the bandwidth value. Alternatively, the alpha value may be a search key on the basis of which the bandwidth value is retrieved from data storage. Apparatus 401 uses bandwidth value 406 for generating a local oscillator signal 407 but local oscillator signal 407 is not necessarily originated directly from an oscillator 408. At least bandwidth value 406 effects to characteristics of local oscillator signal 407. A mixer 409, or a corresponsive device, shapes received signal 405 with local oscillator signal 407. The shaping may effect a frequency translation of received signal 405 with local oscillator signal 407. In one embodiment, oscillator 408 comprises a plurality of oscillator cores and one of these oscillator cores is selected on the basis of bandwidth value 406 after which the selected oscillator core generates local oscillator signal 407.

FIG. 4B shows an embodiment of apparatus 401 comprising a signal shaper 411. Signal shaper 411 provides technical means for shaping received signal 405. In one embodiment, signal shaper 411 comprises an oscillator 408, a mixer 409 (or a corresponsive device), and a divider 412. Oscillator 408 comprises a plurality of oscillator cores 4081, 4082 and 4083. Apparatus 401 selects, based on the bandwidth value 406, one oscillator core (e.g. 4081) and further configures a divider 412 to generate local oscillator signal 407. Divider 412 obtains an output signal 413 of the selected oscillator core and the bandwidth value 406 as input signals. Divider 412 results in the local oscillator signal 407 by dividing output signal 413 of the selected oscillator core with a division ratio that may take one of a number of different division ratio values, depending on which of oscillator core 4081, 4082 and 4083 is currently being used. For example, a local oscillator frequency of 1 GHz may be obtained by operating local oscillator core 4081 at a frequency of 2 GHz, and configuring divider 412 to a division ratio of 2. Alternatively, the same local oscillator frequency may be obtained by operating local oscillator core 4082 at a frequency of 4 GHz and configuring divider 412 to a division ratio of 4. Oscillator cores 4081, 4082, 4083 may, in combination with the variable division ratio, exhibit different phase noise spectra with various shapes and bandwidths, thus bandwidth value 406 effectively controls a phase noise bandwidth of local oscillator signal 407. In FIG. 4B apparatus 401 comprises signal shaper 411. In another embodiment signal shaper 411 is not a part of apparatus 401 but apparatus 401 controls with bandwidth value 406 the operation of signal shaper 411.

FIG. 4C shows an embodiment of a signal shaper 411. Apparatus 401 is not shown but bandwidth value 406 is originated from apparatus 401. Signal shaper 411 comprises a phase-locked loop (PLL) 422 which comprises an oscillator 408, a phase detector 420 and a loop filter 440. Phase detector 420 compares an output signal 413 of oscillator 408 to a reference signal 440 originated from a reference source 430. Reference source 430 may be obtained from a crystal oscillator such as 52 MHz, or from another phase-locked loop that operates on a reference signal from a crystal oscillator, for example. In more detail, phase detector 420 compares the phase of output signal 413 to the phase of reference signal 440 and, on the basis of this comparison, phase detector 420 generates a voltage signal 424 which represents the difference between these two phases. Loop filter 440 obtains voltage signal 424 and bandwidth value 406 as its inputs and generates on the basis of these inputs an oscillator control signal 426. Loop filter 440 may perform lowpass filtering. Oscillator control signal 426 defines characteristics of an output signal 413 of oscillator 408. Oscillator 408 feeds output signal 413 to phase detector 420 and to divider 412. Divider 412 in FIG. 4C uses constantly the same division ratio for the output signal 413. The PLL 422 stabilizes a frequency of oscillator 408, relative to a frequency of the reference signal 440. In one embodiment, apparatus 401 configures a bandwidth of loop filter 440 to bandwidth value 406. For example, apparatus 401 may configure the size of a resistor or a capacitor in loop filter 440 to vary a filter bandwidth of loop filter 440, and thereby configure a loop bandwidth of PLL 422 that comprises loop filter 440 in a feedback loop.

The following embodiments can be utilized with apparatus 411 (in FIGS. 4A, 4B, 4C) or with the method described in FIG. 3. In one embodiment, bandwidth value 406 controls a bandwidth of a phase noise component in local oscillator signal 407. In one embodiment, the using 303 of bandwidth value 406 comprises a selection of an oscillator core among a plurality of oscillator cores (4081, 4082, 4083). In one embodiment, the generating of local oscillator signal 407 (in step 303) comprises a frequency division operation, wherein the frequency division operation is arranged based on bandwidth value 406. In one embodiment, the generating of local oscillator signal 407 comprises use of a feedback loop. A phase locked loop, such as PLL 422, is an example of the feedback loop. In one embodiment, the feedback loop comprises a loop filter 440 that is arranged based on bandwidth value 406.

The following embodiments describe the composition of apparatus 401 (in FIGS. 4A, 4B, 4C). In one embodiment, apparatus operates as a control device which determines bandwidth value 406 and comprises (only) at least one processor 402 and at least one memory 403 including computer program code 404. In one embodiment, apparatus 401 further comprises a signal shaper (e.g. signal shaper 411 in FIG. 4B or signal shaper 411 in FIG. 4C). Signal shaper 411 comprises an oscillator 408 and at least one of the following devices: a mixer 409, a divider 412, a phase detector 420, a loop filter 440, a PLL 422. Oscillator 408 may comprise a plurality of oscillator cores. A person skilled in the art is able to combine a variable divider 412 (in FIG. 4B), a fixed divider 412 (in FIG. 4C), a variable oscillator 408 (in FIG. 4B), a fixed oscillator 408 (in FIG. 4C), a PLL 422 (in FIG. 4C), and/or other known prior art components to build a signal shaper for purposes of the present invention.

The present invention further comprises a computer readable medium. That medium stores a set of instructions which, when executed, causes an apparatus (such as apparatus 401) to perform the steps described in FIG. 3.

The present invention may be implemented in software, hardware, application logic or a combination of software, hardware and application logic. The hardware may be, for example, a chip, a modem, or some other apparatus which includes or is coupled to at least memory and at least one processor. The application logic, software or instruction set is maintained on any one of various conventional computer-readable media. In the context of this document, a “computer-readable medium” may be any media or means that contain, store, communicate, propagate or transport the instructions for use by or in connection with an instruction execution system, apparatus, or device, such as a computer. A computer-readable medium may comprise a computer-readable storage medium that may be any media or means that contain or store the instructions for use by or in connection with an instruction execution system, apparatus, or device, such as a computer.

When not otherwise mentioned, “one embodiment” in the above refers to “one embodiment of the present invention”. The exemplary embodiments can store information relating to various processes described herein. This information can be stored in one or more memories, such as a hard disk, optical disk, magneto-optical disk, RAM, and the like.

All or a portion of the exemplary embodiments can be conveniently implemented using one or more general purpose processors, microprocessors, digital signal processors, micro-controllers, and the like, programmed according to the teachings of the exemplary embodiments of the present invention, as will be appreciated by those skilled in the computer and/or software art(s). Appropriate software can be readily prepared by programmers of ordinary skill based on the teachings of the exemplary embodiments, as will be appreciated by those skilled in the software art. In addition, the exemplary embodiments can be implemented by the preparation of application-specific integrated circuits, field-programmable gate arrays (FPGAs) or by interconnecting an appropriate network of conventional component circuits, as will be appreciated by those skilled in the electrical art(s). Thus, the exemplary embodiments are not limited to any specific combination of hardware and/or software.

Stored on any one or on a combination of computer readable media, the exemplary embodiments of the present invention can include software for controlling the components of the exemplary embodiments, for driving the components of the exemplary embodiments, for enabling the components of the exemplary embodiments to interact with a human user, and the like. Such software can include, but is not limited to, device drivers, firmware, operating systems, development tools, applications software, and the like. Such computer readable media further can include the computer program of an embodiment of the present invention for performing all or a portion (if processing is distributed) of the processing performed in implementing the present invention. Computer code devices of the exemplary embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed:

1. A method of enhancing quality of a received signal in a receiver, the method comprising:
determining input information that comprises at least one of the following pieces of information:
a modulation-and-coding scheme of the received signal;
a multiple-antenna configuration;
a signal quality estimate of the received signal; and
a frequency separation between the received signal and a transmitted signal;
selecting a bandwidth value on the basis of the input information;
using the bandwidth value for generating a local oscillator signal; and
shaping the received signal with the local oscillator signal.

2. The method according to claim 1, wherein the bandwidth value controls a bandwidth of a phase noise component in the local oscillator signal.

3. The method according to claim 1, wherein the using of the bandwidth value comprises a selection of an oscillator core.

4. The method according to claim 1, wherein the generating of the local oscillator signal comprises at least one of a frequency division operation and a use of a feedback loop.

5. The method according to claim 1, wherein the input information comprises at least two of the following pieces of information:
the modulation-and-coding scheme of the received signal;
the multiple-antenna configuration;
the signal quality estimate of the received signal;
the frequency separation between the received signal and a transmitted signal.

6. The method according to claim 5, wherein the selecting is performed taking into account the at least two pieces of information.

7. The method according to claim 1, wherein the signal quality estimate is a channel quality indicator.

8. The method according to claim 1, wherein the frequency separation is determined on the basis of at least one of a threshold value and a band used by the receiver, the band comprising an uplink frequency band and a downlink frequency band.

9. An apparatus, comprising:
at least one processor and at least one memory including computer program code, the at least one processor and the computer program code configured to, with the at least one processor, cause the apparatus to perform, at a user equipment, at least the following:
determining input information that comprises at least one of the following pieces of information:
a modulation-and-coding scheme of the received signal;
a multiple-antenna configuration;
a signal quality estimate of the received signal; and
a frequency separation between the received signal and a transmitted signal;
selecting a bandwidth value on the basis of the input information;
using the bandwidth value for generating a local oscillator signal; and
shaping a received signal with the local oscillator signal to enhance quality of the received signal in a receiver.

10. The apparatus according to claim 9, wherein the bandwidth value controls a bandwidth of a phase noise component in the local oscillator signal.

11. The apparatus according to claim 9, wherein the using of the bandwidth value comprises a selection of an oscillator core.

12. The apparatus according to claim 9 wherein the generating of the local oscillator signal comprises at least one of a frequency division operation and use of a feedback loop.

13. The apparatus according to claim 9, wherein the input information comprises at least two of the following pieces of information:
the modulation-and-coding scheme of the received signal;
the multiple-antenna configuration;
the signal quality estimate of the received signal;
the frequency separation between the received signal and a transmitted signal.

14. The apparatus according to claim 13, wherein the selecting is performed taking into account the at least two pieces of information.

15. The apparatus according to claim 9, wherein the signal quality estimate is a channel quality indicator.

16. The apparatus according to claim 9, wherein the frequency separation is determined on the basis of at least one of a threshold value and a band used by the receiver, the band comprising an uplink frequency band and a downlink frequency band.

17. The apparatus according to claim 9, wherein the selecting comprises use of a conditional clause.

18. The apparatus according to claim 17, wherein the conditional clause comprises at least one predefined threshold values.

19. The apparatus according to any of claim 9, wherein the apparatus comprises a signal shaper for shaping the received signal.

20. The apparatus according to claim 19, wherein the signal shaper comprises an oscillator and at least one the following devices: a mixer, divider, a phase detector, a loop filter, a phase locked loop.

21. A non-transitory computer readable medium comprising a set of computer readable instructions stored thereon, which, when executed by a processing system, cause the processing system to enhance quality of a received signal in a receiver by performing at least:
determining input information that comprises at least one of the following pieces of information:
a modulation-and-coding scheme of the received signal;
a multiple-antenna configuration;
a signal quality estimate of the received signal; and
a frequency separation between the received signal a transmitted signal;
selecting a bandwidth value on the basis of the input information;
using the bandwidth value for generating a local oscillator signal; and
shaping the received signal with the local oscillator signal.
